(19) United States
(12) Patent Application Publication
(10) Pub. No.: US 2024/0368472 A1
(43) Pub. Date: Nov. 7, 2024

(54) HYDROXYL AMINE SURFACTANT COMPOSITIONS

(71) Applicant: Dow Global Technologies LLC, Midland, MI (US)

(72) Inventors: Cheng Shen, Shanghai (CN); Haiying Li, Shanghai (CN); Shaoguang Feng, Shanghai (CN); Jian Zou, Shanghai (CN); Wanglin Yu, Pearland, TX (US)

(21) Appl. No.: 18/572,436

(22) PCT Filed: Oct. 6, 2021
(86) PCT No.: PCT/CN2021/122515

§ 371 Date: Dec. 20, 2023

(51) Int. Cl. C09K 23/00; C09K 23/16; C09K 23/42

(52) U.S. Cl. CPC C09K 23/018; C09K 23/002; C09K 23/16; C09K 23/42

(57) ABSTRACT

A surfactant composition includes 60 wt % or greater of a surfactant based on a total weight of the surfactant composition and 0.01 wt % to 5 wt % of a hydroxyl amine having structure (I) based on the total weight of the surfactant composition, wherein R₁, R₂ and R₃ of Structure (I) are independently selected from the group consisting of H, an alkanolamine, or a hydroxyl alkyl group with linear or branched carbon chain having from 1 to 8 carbons, and R₄ of Structure (I) is selected from the group consisting of an alkanolamine, or a hydroxyl alkyl group with linear or branched carbon chain having from 1 to 8 carbons.

### BACKGROUND

### Field of the Disclosure

The present disclosure is directed to a surfactant composition and more specifically to a surfactant composition that comprises hydroxyl amines and exhibits a reduced concentration of volatile organic compounds.

### INTRODUCTION

Volatile organic compounds (“VOCs”) are compounds having a high vapor pressure. VOCs are introduced into products and compositions in a variety of manners. For example, the manufacturing of a product may leave VOCs in the product that will off gas over time. Additionally or alternatively, VOCs can be produced during storage of a product as a result of oxidation or exposure to elevated thermal conditions. Examples of VOCs include aldehydes, ketones, and various forms of acids. VOCs are typically emitted as gases from the product and may produce offensive odors and cause other issues. In view of these concerns, consumers and manufacturers have a heightened attention to the removal or reduction of VOCs in products.

Attempts have been made at addressing common VOCs. For example, World Intellectual Property Organization Publication 2018148898 (“the '898 publication”) discloses the use of polyurethane foams that exhibit reduced levels of formaldehyde and acetaldehyde emissions. The '898 publication discloses in Tables 1 and 3 that the use of 2-amino-2 (hydroxymethyl) propane-1,3-diol (i.e., example 2) has an effect of lowering acetaldehyde, but limited effect on other VOCs present. Similarly to the '898 publication, U.S. Pat. No. 8,007,545 (“the '545 patent”) discloses a deodorizing composition using 2-amino-2-hydroxymethyl-1,3-propanediol. As demonstrated by Table 1 of the '545 patent, the deodorizing composition was able to reduce aldehyde smells but not below a detectable threshold for a human nose.

In view of the foregoing, it would be surprising to discover a composition utilizing an amine compound that is able to significantly reduce the concentration of aldehyde, ketone, ester, alcohol and acid VOCs simultaneously.

### SUMMARY OF THE DISCLOSURE

The inventors of the present application have discovered a composition that exhibits a significantly reduced total VOC content and that simultaneously reduces of aldehyde, ketone, ester, alcohol and acid VOCs as a result of including a hydroxyl amine compound. The inventors of the present application have discovered that the incorporation of 0.01 weight percent (“wt %”) to 5 wt % of a hydroxyl amine having structure (I) into a surfactant composition comprising 60 wt % or greater of a surfactant simultaneously reduces aldehyde, ketone, ester, alcohol and acid VOCs. Such a result is advantageous in that it allows for the production and distribution of surfactant compositions that will not significantly contribute to a down stream product's total VOC content. Additionally, the inventors of the present disclosure have also discovered that the addition of sodium bisulfite to the surfactant composition can also aid in the reduction of various VOCs.

The present invention is particularly useful in cleaning, coating, and adhesive applications.

According to a first feature of the present disclosure, a surfactant composition includes 60 wt % or greater of a surfactant based on a total weight of the surfactant composition and 0.01 wt % to 5 wt % of a hydroxyl amine having structure (I) based on the total weight of the surfactant composition, wherein R₁, R₂ and R₃ are independently selected from the group consisting of H, an alkanolamine, or a hydroxyl alkyl group with linear or branched carbon chain having from 1 to 8 carbons, and R₄ selected from the group consisting of an alkanolamine, or a hydroxyl alkyl group with linear or branched carbon chain having from 1 to 8 carbons.

According to a second feature of the present disclosure, the surfactant composition comprises 75 wt % or greater of the surfactant based on the total weight of the surfactant composition.

According to a third feature of the present disclosure, the surfactant composition comprises from 0.01 wt % to 1 wt % of the hydroxyl amine based on the total weight of the surfactant composition.

According to a fourth feature of the present disclosure, the surfactant is an ethoxylated non-ionic surfactant and the surfactant comprises 8 or 9 moles of ethylene oxide on average.

According to a fifth feature of the present disclosure, the surfactant composition further comprises sodium bisulfite.

According to a sixth feature of the present disclosure, the surfactant composition comprises from 0.01 wt % to 0.5 wt % of the sodium bisulfite based on the total weight of the surfactant composition.

According to a seventh feature of the present disclosure, the surfactant has structure (II) and n of structure (II) is 3 to 11.

According to an eighth feature of the present disclosure, the surfactant has structure (III) wherein x of structure (III) is 2 to 8 and y of structure (III) is 3 to 40.

According to a ninth feature of the present disclosure, the hydroxyl amine is selected from the group consisting of tris (hydroxyl-methyl) amino-methane, diethanolamine and combinations thereof.

According to a tenth feature of the present disclosure, the hydroxyl amine is diethanolamine.

### Surfactant Compositions

The present disclosure is directed to a surfactant composition. The surfactant composition includes a surfactant and a hydroxyl amine. The surfactant composition may also comprise sodium bisulfite. As explained in greater detail below, the introduction of the antioxidant and the hydroxyl amine aid in reducing and/or eliminating a variety of VOCs from the surfactant composition such that the surfactant composition does not significantly contribute to the VOC content of downstream applications.

### Hydroxyl Amine

The surfactant composition comprises the hydroxyl amine. As used herein, the term “hydroxyl amine” means a chemical compound having both anime and hydroxyl groups, functionalities, or moieties. The hydroxyl amine is characterized by Structure (I)

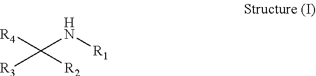

wherein R₁, R₂ and R₃ are independently selected from the group consisting of H, an alkanolamine, or a hydroxyl alkyl group with linear or branched carbon chain having from 1 to 8 carbons, and R₄ selected from the group consisting of an alkanolamine, or a hydroxyl alkyl group with linear or branched carbon chain having from 1 to 8 carbons. The hydroxyl amine may be selected from the group consisting of diethanolamine, tris (hydroxyl-methyl) amino-methane, aminoethyl ethanolamine, diisopropanolamine, 2-amino-1-butanol, 2-amino-2-ethyl-1,3-propanediol, 2-amino-2-methyl-1-propanol, 2-amino-1-methyl-1,3-propanediol, N-methylethanolamine, N-butylethanolamine, monoisopropanolamine, mono-sec-butanolamine, di-sec-butanolamine other hydroxyl amines and combinations thereof.

The surfactant composition may comprise 0.01 wt % to 5 wt % of the hydroxyl amine based on the total weight of the surfactant composition: For example, the surfactant composition may comprise 0.01 wt % or greater, or 0.05 wt % or greater, or 0.10 wt % or greater, or 0.25 wt % or greater, or 0.50 wt % or greater, or 0.75 wt % or greater, or 1.00 wt % or greater, or 1.50 wt % or greater, or 2.00 wt % or greater, or 2.50 wt % or greater, or 3.00 wt % or greater, or 3.50 wt % or greater, or 4.00 wt % or greater, or 4.50 wt % or greater, while at the same time, 5.00 wt % or less, or 4.50 wt % or less, or 4.00 wt % or less, or 3.50 wt % or less, or 3.00 wt % or less, or 2.50 wt % or less, or 2.00 wt % or less, or 1.50 wt % or less, or 1.00 wt % or less, 0.75 wt % or less, or 0.50 wt % or less, or 0.25 wt % or less, or 0.10 wt % or less, or 0.05 wt % or less of the hydroxyl amine based on the total weight of the surfactant composition.

### Surfactant

As stated above, the surfactant composition comprises the surfactant. As used herein, the term “surfactant” means a compound that lowers the interfacial tension between two immiscible phases of dissimilar chemistry. The surfactant may be ionic or non-ionic. The surfactant may be alkoxylated with one or more ethylene oxide (i.e., ethoxylated), propylene oxide (i.e., propoxylated) and/or butylene oxide (i.e., butoxylated) components. The surfactant may have Structure (II)

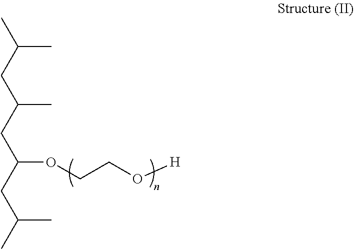

wherein n of structure (II) is 3 or greater, or 4 or greater, or 5 or greater, or 6 or greater, or 7 or greater, or 8 or greater, or 9 or greater, or 10 or greater, while at the same time, 11 or less, or 10 or less, or 9 or less, or 8 or less, or 7 or less, or 6 or less, or 5 or less, or 4 or less. The variables “n” describes the average molar units of oxyethylene in structure (II). As defined herein n value is tested and determined by Proton Nuclear Magnetic Resonance Spectroscopy and Carbon-13 Nuclear Magnetic Resonance Spectroscopy. The surfactant may have Structure (III)

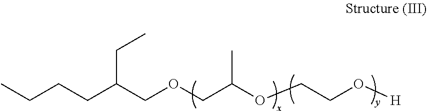

wherein y of structure (III) is 3 or greater, or 4 or greater, or 5 or greater, or 10 or greater, or 15 or greater, or 20 or greater, or 25 or greater, or 30 or greater, or 35 or greater, while at the same time, 40 or less, or 35 or less, or 30 or less, or 25 or less, or 20 or less, or 15 or less, or 10 or less, or 5 or less, or 4 less. X of structure (III) is 2 or greater, or 3 or greater, or 4 or greater, or 5 or greater, or 6 or greater, or 7 or greater, while at the same time, 8 or less, or 7 or less, or 6 or less, or 5 or less, or 4 or less, or 3 or less. The variable “x” describes the average molar units of oxypropylene utilized in structure (III) and the variable “y” describes the average molar units of oxyethylene in structure (III). As defined herein, the x and y values are tested and determined by Proton Nuclear Magnetic Resonance Spectroscopy and Carbon-13 Nuclear Magnetic Resonance Spectroscopy. The surfactant may be a blend of surfactants such as Structure (II), Structure (III) and/or other surfactants.

The surfactant composition comprises 60 wt % or greater of the surfactant based on the total weight of the surfactant composition. For example, the surfactant composition may comprise 60 wt % or greater, or 61 wt % or greater, or 62 wt % or greater, or 63 wt % or greater, or 64 wt % or greater, or 65 wt % or greater, or 66 wt % or greater, or 67 wt % or greater, or 68 wt % or greater, or 69 wt % or greater, or 70 wt % or greater, or 71 wt % or greater, or 72 wt % or greater, or 73 wt % or greater, or 74 wt % or greater, or 75 wt % or greater, or 76 wt % or greater, or 77 wt % or greater, or 78 wt % or greater, or 79 wt % or greater, or 80 wt % or greater, or 81 wt % or greater, or 82 wt % or greater, or 83 wt % or greater, or 84 wt % or greater, or 85 wt % or greater, or 86 wt % or greater, or 87 wt % or greater, or 88 wt % or greater, or 89 wt % or greater, or 90 wt % or greater, or 91 wt % or greater, or 92 wt % or greater, or 93 wt % or greater, or 94 wt % or greater, or 95 wt % or greater, or 96 wt % or greater, or 97 wt % or greater, or 98 wt % or greater, or 99 wt % or greater, while at the same time, 99.98 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less, or 90 wt % or less, or 89 wt % or less, or 88 wt % or less, or 87 wt % or less, or 86 wt % or less, or 85 wt % or less, or 84 wt % or less, or 83 wt % or less, or 82 wt % or less, or 81 wt % or less, or 80 wt % or less, or 79 wt % or less, or 78 wt % or less, or 77 wt % or less, or 76 wt % or less, or 75 wt % or less, or 74 wt % or less, or 73 wt % or less, or 72 wt % or less, or 71 wt % or less, or 70 wt % or less, or 69 wt % or less, or 68 wt % or less, or 67 wt % or less, or 66 wt % or less, or 65 wt % or less, or 64 wt % or less, or 63 wt % or less, or 62 wt % or less, or 61 wt % or less based on the total weight of the surfactant composition.

### Sodium Bisulfite

The surfactant composition may comprise sodium bisulfite. Sodium bisulfite has a CAS number of 7631-90-5. The surfactant composition may comprise 0.01 wt % to 0.50 wt % of the sodium bisulfite. For example, the surfactant composition comprises 0.01 wt % or greater, or 0.02 wt % or greater, or 0.04 wt % or greater, or 0.06 wt % or greater, or 0.08 wt % or greater, or 0.10 wt % or greater, or 0.20 wt % or greater, or 0.30 wt % or greater, or 0.40 wt % or greater, while at the same time, 0.50 wt % or less, or 0.40 wt % or less, or 0.30 wt % or less, or 0.20 wt % or less, or 0.10 wt % or less, or 0.08 wt % or less, or 0.06 wt % or less, or 0.04 wt % or less, or 0.02 wt % or less of the sodium bisulfite based on the total weight of the surfactant composition. The surfactant composition may have a weight ratio of hydroxyl amine to sodium bisulfite of 1:10, or 1:9, or 1:8, or 1:7, or 1:6, or 1:5, or 1:4, or 1:3, or 1:2, or 1:1, while at the same time, 2:1, or 3:1, or 4:1, or 5:1, or 6:1, or 7:1, or 8:1, or 9:1, or 10:1.

### EXAMPLES

### Materials

The following materials were used in the examples.

Surfactant 1 is Structure (III) with an x of 5 and a y of 9 and having a CAS number of 64366-70-7. Surfactant 1 has 99 wt % or greater actives and is available from The Dow Chemical Company, Midland, MI, USA.

Surfactant 2 is Structure (II) with an n of 3 having a CAS number of 60828-78-6. having Surfactant 2 is a 90 wt % actives and 10 wt % aqueous composition and is available from The Dow Chemical Company, Midland, MI, USA.

DEA is diethanolamine having a CAS number of 111-42-2 and is available from The Dow Chemical Company, Midland, MI, USA.

TAM is tris(hydroxymethyl)aminomethane having a CAS number of 77-86-1 and available from Sigma-Aldrich, St. Louis, MO.

NAS is an aqueous solution of 25 wt % sodium bisulfite. The sodium bisulfite has a CAS number of 7631-90-5 and is available from Sigma-Aldrich, St. Louis, MO.

### Sample Preparation and Testing

The comparative examples (“CE”) and inventive examples (“IE”) were prepared by first combining the designated constituents in a sample container. The container was then placed on a shaking table for two hours and 300 revolutions per minute. All samples exhibited a homogenous appearance at the end of shaking. The comparative and inventive examples were heated to 70° C. for 24 hours before headspace gas chromatography-mass spectrometry (“HS GCMS”) analysis was performed on the examples. A control sample of neat surfactant 2 was placed in a container and kept at approximately 23° C. for 24 hours.

For data in Table 2, the testing method was as following: An Agilent 7890A Gas chromatograph, an Agilent 5975C mass spectrometer and an Agilent 7697A headspace auto sampler were utilized to analyze the examples. The Gas chromatograph column was an SolGel-wax column having a 30 mm×250 μm×1 μm dimension. The carrier gas used was helium at 1.0 mL/minute constant flow. The gas chromatograph oven program was 50° C. hold 5 minutes, 10° C./minute ramp to 250° C., hold 3 minutes. The Gas chromatograph was set in scan mode with a source temperature of 230° C., a MS Quad temperature of 150° C., and an acquisition scan mode looking for masses from 29 Daltons to 400 Daltons. The headspace oven was heated to 130° C. for 15 minutes. The HS GCMS was performed on 20-30 mg of sample that was put into 20 mL headspace vials for analysis. All samples were prepared for duplicate, and the average results are provided. All VOCs were semi-quantified using toluene as equivalent, and their response factor to toluene was regarded as ‘1’. An aliquot of 2.0 μg of toluene was injected into headspace vial, and toluene peak area was used for semi-quantification.

For data in Table 3 and 4, the testing method was as following: An Agilent 7890A Gas chromatograph, an Agilent 5975C mass spectrometer and an Agilent 7697A headspace auto sampler were utilized to analyze the examples. The Gas chromatograph column was an Agilent DB-5MS column (J&W 123-5533) having a 30 mm×320 μm×1 μm dimension. The carrier gas used was helium at 1.5 mL/minute constant flow. The gas chromatograph oven program was 50° C., hold 5 minutes, 10° C./minute ramp to 250° C., hold 3 minutes. The Gas chromatograph was set in scan mode with a source temperature of 230° C., a MS Quad temperature of 150° C., and an acquisition scan mode looking for masses from 29 Daltons to 400 Daltons. The headspace oven was heated to 130° C. for 15 minutes. The sample preparing procedures were same as above.

### Results

Table 1 provides the composition of CE1-CE5, IE1-IE5 and the control sample.

TABLE 1

| | | | | | Sodium |
|---|---|---|---|---|---|
| | Surfactant 1 | Surfactant 2 | DEA | TAM | Bisulfite |
| Ex | (wt %) | (wt %) | (wt %) | (wt %) | (wt %) |
| Control | | 100 | | | |
| CE1 | 100 | | | | |
| IE1 | 99.8 | | | 0.2 | |
| CE2 | 100 | | | | |
| IE2 | 99.9 | | 0.1 | | |
| CE3 | | 100 | | | |
| IE3 | | 99.95 | 0.05 | | |
| IE4 | | 99.9 | 0.1 | | |
| CE4 | | 99.95 | | | 0.05 |
| CE5 | | 99.9 | | | 0.1 |
| IE5 | | 99.9 | 0.05 | | 0.05 |

Tables 2 and 3 demonstrate the effect of adding a hydroxyl amine to surfactant 1.

TABLE 2

| VOC | CE1 | IE1 |
|---|---|---|
| 4-heptanone | 5.6 | 1.9 |
| 3-heptanone | 14.5 | 10.1 |
| 2-heptanone | 4.6 | 0.8 |
| Hexanal, 2-ethyl- | 128.0 | 25.3 |
| 2-propanone, 1- | 9.7 | 3.1 |
| hydroxy- | | |
| Carbonic acid, 2- | 27.2 | 16.4 |
| ethylhexyl isobutyl | | |
| ester | | |
| Acetic acid | 283.1 | 114.0 |
| 1,2-propanediol, | 23.0 | 14.3 |
| 1-acetate | | |
| 1,2-propanediol, 2- | 9.0 | 3.4 |
| acetate | | |
| 1,2-ethanediol, | 12.7 | 4.0 |
| monoacetate | | |
| Total impurities | 517.4 | 193.3 |
| reduction (ppm) | | |

TABLE 3

| VOC | CE2 | IE2 |
|---|---|---|
| Acetic acid | 109.8 | 11.1 |
| 2-propanone, 1- | 4.0 | 0.4 |
| hydroxy- | | |
| 4-heptanone | 6.9 | 1.0 |
| 1,2-propanediol, 1- | 2.3 | 0 |
| acetate | | |
| 3-heptanone | 7.0 | 2.1 |
| 2-heptanone | 11.8 | 3.6 |
| Hexanal, 2-ethyl- | 2.2 | 0 |
| Carbonic acid, 2- | 79.6 | 8.7 |
| ethylhexyl isobutyl | | |
| ester | | |
| Formic acid, 2- | 20.1 | 3.8 |
| ethylhexyl ester | | |
| 3-methyl-4- | 18.1 | 3.5 |
| heptanone | | |
| Total impurities | 261.8 | 34.2 |
| reduction (ppm) | | |

Table 4 demonstrates the effect of adding a hydroxyl amine alone or in combination with sodium bisulfite to Surfactant 2.

TABLE 4

| | Con- | | | | | | |
|---|---|---|---|---|---|---|---|
| VOC | trol | CE3 | IE3 | IE4 | CE 4 | CE 5 | IE 5 |
| Formic acid | 245.6 | 261.0 | 4.1 | 0.8 | 44.9 | 112.0 | 0.7 |
| Propanal, | 101.9 | 113.0 | 39.4 | 7.5 | 99.1 | 134.2 | 4.0 |
| 2-methyl | | | | | | | |
| Butanal | 128.7 | 144.2 | 49.4 | 4.8 | 112.9 | 123.5 | 2.7 |
| Acetalde- | 15.9 | 14.1 | 6.7 | 1.6 | 14.4 | 18.0 | 3.6 |
| hyde, | | | | | | | |
| Hydroxy- | | | | | | | |
| Butanal, | 17.2 | 12.9 | 5.0 | 1.7 | 114.2 | 127.9 | 4.7 |
| 3-methyl- | | | | | | | |
| Methyl | 18.3 | 25.2 | 7.2 | 0.6 | 25.9 | 25.4 | 2.8 |
| formate | | | | | | | |
| Methyl | 93.1 | 115.5 | 40.8 | 8.2 | 174.2 | 151.0 | 8.9 |
| isobutyl | | | | | | | |
| ketone | | | | | | | |
| 1,2- | 243.8 | 321.6 | 66.7 | 16.9 | 224.1 | 282.5 | 16.5 |
| ethanediol, | | | | | | | |
| monoformate | | | | | | | |
| Pentanal, | 65.0 | 76.5 | 24.2 | 6.3 | 57.6 | 82.7 | 4.7 |
| 2,4- | | | | | | | |
| dimethyl- | | | | | | | |
| 1,2- | 60.7 | 87.8 | 12.3 | 2.5 | 64.3 | 70.4 | 4.7 |
| ethanediol, | | | | | | | |
| diformate | | | | | | | |
| 2-hexanone, | 0.9 | 0.9 | 0.4 | 0.2 | 1.2 | 1.1 | 0.3 |
| 4-methyl- | | | | | | | |
| 2-hexanone, | 1.2 | 1.3 | 0.7 | 0.3 | 1.6 | 2.4 | 0.2 |
| 5-methyl- | | | | | | | |
| 2-pentanone, | 427.7 | 674.2 | 202.8 | 79.0 | 415.0 | 680.6 | 37.0 |
| 4-hydroxy- | | | | | | | |
| 4-methyl- | | | | | | | |
| Total VOCs | 1420.0 | 1839.2 | 459.7 | 130.4 | 1349.2 | 1911.7 | 90.8 |
| (ppm) | | | | | | | |

As can be seen from Tables 2-4, the addition of a hydroxyl amine alone or in combination with sodium bisulfite advantageously lowers the total VOC content of the example. IE1 compared to CE1 demonstrates that the inclusion of tris(hydroxymethyl)aminomethane at only 0.2 wt % is enough to produce a surfactant composition with less than half the VOCs of a sample having no tris(hydroxymethyl)aminomethane (e.g., CE1). IE2 compared to CE2 demonstrates that the inclusion of diethanolamine at only 0.1 wt % is enough to produce a surfactant composition with less than 15% of the VOCs of a sample having no diethanolamine (e.g., CE2).

Referring now to Table 4, provided is a control of surfactant 2 that had not been subjected to heat aging for reference purposes. As can be seen, IE3-IE5 vastly outperform the control and CE3-CE5 in removing the total VOC content thereby demonstrating that the introduction of hydroxyl amines is beneficial in removing the VOCs. IE3-IE5 also exhibit lower VOC counts than the control sample indicating that the introduction of hydroxyl amines is beneficial even in addressing VOCs already present in the surfactant from manufacture. IE5 demonstrates that the combination of sodium bisulfite and hydroxyl amine as the effect of lowering the total VOC count even further than hydroxyl amine usage alone. This result is surprising because the hydroxyl amine and sodium bisulfite exhibit a synergistic effect in reducing the total VOCs present in the surfactant composition.

What is claimed is:

1. A surfactant composition, comprising:
60 wt % or greater of a surfactant based on a total weight of the surfactant composition; and
0.01 wt % to 5 wt % of a hydroxyl amine having structure (I) based on the total weight of the surfactant composition: 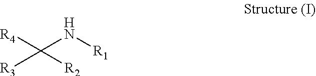
wherein R₁, R₂ and R₃ are independently selected from the group consisting of H, an alkanolamine, or a hydroxyl alkyl group with linear or branched carbon chain having from 1 to 8 carbons, and R₄ selected from the group consisting of an alkanolamine, or a hydroxyl alkyl group with linear or branched carbon chain having from 1 to 8 carbons.

2. The surfactant composition of claim 1, wherein the surfactant composition comprises 75 wt % or greater of the surfactant based on the total weight of the surfactant composition.

3. The surfactant composition of claim 2, wherein the surfactant composition comprises from 0.01 wt % to 1 wt % of the hydroxyl amine based on the total weight of the surfactant composition.

4. The surfactant composition of claim 1, wherein the surfactant is an ethoxylated non-ionic surfactant and the surfactant comprises 8 or 9 moles of ethylene oxide on average.

5. The surfactant composition of claim 1, further comprising sodium bisulfite.

6. The surfactant composition of claim 5, wherein the surfactant composition comprises from 0.01 wt % to 0.5 wt % of the sodium bisulfite based on the total weight of the surfactant composition.

7. The surfactant composition of claim 1, wherein the surfactant has structure (II) 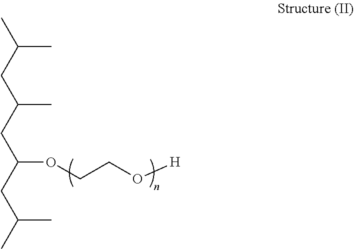
wherein n of structure (II) is 3 to 11.

8. The surfactant composition of claim 1, wherein the surfactant has structure (III) 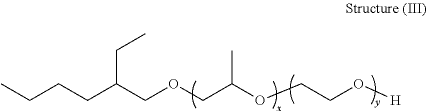
wherein x of structure (III) is 2 to 8 and y of structure (III) is 3 to 40.

9. The surfactant composition of claim 1, wherein the hydroxyl amine is selected from the group consisting of tris (hydroxyl-methyl) amino-methane, diethanolamine and combinations thereof.

10. The surfactant composition of claim 9, wherein the hydroxyl amine is diethanolamine.
